(19) United States
(12) Patent Application Publication
(10) Pub. No.: US 2015/0249722 A1
(43) Pub. Date: Sep. 3, 2015

(54) CONTENT PROVIDING APPARATUS AND METHOD, AND COMPUTER PROGRAM PRODUCT

(71) Applicant: Kabushiki Kaisha Toshiba, Minato-ku (JP)

(72) Inventors: Mika MINEMATSU, Fuchu (JP); Hiroyuki AIZU, Yokohama (JP); Narumichi SAKAI, Fujisawa (JP)

(73) Assignee: Kabushiki Kaisha Toshiba, Minato-ku (JP)

(21) Appl. No.: 14/600,167

(22) Filed: Jan. 20, 2015

(30) Foreign Application Priority Data
Feb. 28, 2014 (JP) 2014-039637

(51) Int. Cl. H04L 29/08; H04L 29/06

(52) U.S. Cl. CPC H04L 67/2823; H04L 67/42

(57) ABSTRACT

According to an embodiment, a content providing apparatus includes a receiving unit, an analyzing unit, a determining unit, a changing unit, and a transmitting unit. The receiving unit receives a request for content from a communication terminal. The analyzing unit analyzes the content requested by the communication terminal. The determining unit determines a method for changing the content, based on a result of the analysis by the analyzing unit and communication terminal information indicating performance or state of the communication terminal. The changing unit changes the content by the change method determined by the determining unit. The transmitting unit transmits the content changed by the changing unit to the communication terminal.

### CROSS-REFERENCE TO RELATED APPLICATIONS

This application is based upon and claims the benefit of priority from Japanese Patent Application No. 2014-039637, filed on Feb. 28, 2014; the entire contents of which are incorporated herein by reference.

### FIELD

Embodiments described herein relate generally to a content providing apparatus and method, and a computer program product.

### BACKGROUND

In recent years, various types of communication terminals such as personal computers, mobile phones, smartphones, tablet terminals, and game machines are connected to a network. These communication terminals have different performances such as communication speed, computing power, screen resolution, and screen size and different states such as remaining battery level and packet loss rate. Hence, when content is provided through the network, even if content can be easily displayed on a given communication terminal, the load of the process of displaying the content may be high on other communication terminals.

However, in conventional art, content cannot be provided to a communication terminal by flexibly changing the content based on the performance or states of the communication terminal and the content.

### BRIEF DESCRIPTION OF THE DRAWINGS

FIG. 1 is a diagram illustrating an example of a configuration of a content providing apparatus of a first embodiment;

FIG. 2 is a diagram illustrating an example of script information included in web content;

FIG. 3 is a flowchart illustrating an example of a method for providing content of the first embodiment;

FIG. 4 is a flowchart illustrating a method for determining a method for changing web content of the first embodiment;

FIG. 5 is a diagram illustrating an example of a configuration of a content providing apparatus of a second embodiment;

FIG. 6 is a diagram illustrating an example of layout information of a responsive website;

FIG. 7 is a diagram illustrating an example of a responsive website;

FIG. 8 is a diagram illustrating an example of changes made by the trimming and size reduction of images;

FIG. 9 is a diagram illustrating an example of a change made to specify the position of an image;

FIG. 10 is a flowchart illustrating an example of a method for providing content of the second embodiment;

FIG. 11 is a diagram illustrating an example of a configuration of a content providing apparatus of a third embodiment;

FIG. 12 is a diagram illustrating an example of web content using CSS3 animation;

FIG. 13 is a diagram illustrating an example in which CSS3 animation is changed to a scheme for referring to a moving image file;

FIG. 14 is a flowchart illustrating an example of a method for providing content of the third embodiment;

FIG. 15 is a flowchart illustrating a method for determining a method for changing web content of the third embodiment; and

FIG. 16 is a diagram illustrating an example of a hardware configuration of the content providing apparatuses of the first to third embodiments.

### DETAILED DESCRIPTION

According to an embodiment, a content providing apparatus includes a receiving unit, an analyzing unit, a determining unit, a changing unit, and a transmitting unit. The receiving unit receives a request for content from a communication terminal. The analyzing unit analyzes the content requested by the communication terminal. The determining unit determines a method for changing the content, based on a result of the analysis by the analyzing unit and communication terminal information indicating performance or state of the communication terminal. The changing unit changes the content by the change method determined by the determining unit. The transmitting unit transmits the content changed by the changing unit to the communication terminal.

Various embodiments will be described in detail below with reference to the accompanying drawings. A description of the following embodiments is made of the case in which web content is provided as content.

### First Embodiment

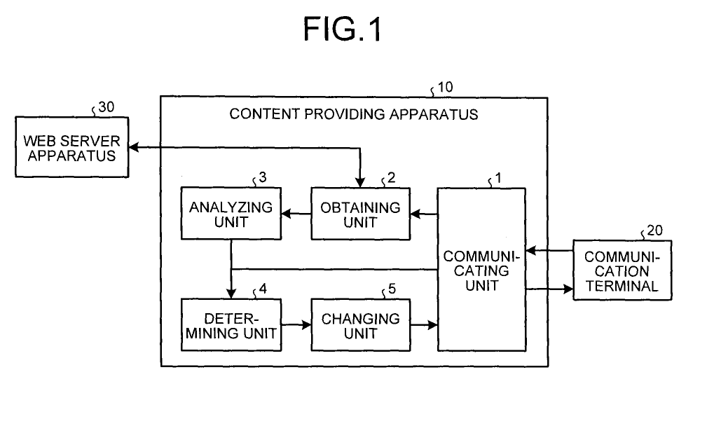

FIG. 1 is a diagram illustrating an example of a configuration of a content providing apparatus 10 of a first embodiment. The content providing apparatus 10 of the first embodiment includes a communicating unit 1, an obtaining unit 2, an analyzing unit 3, a determining unit 4, and a changing unit 5.

The communicating unit 1 receives a request for web content from a communication terminal 20. The request for web content includes a URL (Uniform Resource Locator). The URL is information that specifies the web content on a network. The method for receiving, by the communicating unit 1, a request for web content from the communication terminal 20 may be any. For example, the content providing apparatus 10 may be registered in advance as a proxy server in the browser settings of the communication terminal 20, and when a browser of the communication terminal 20 requests for web content, the communicating unit 1 may receive a request for the web content from the communication terminal 20. Namely, the communicating unit 1 may receive from the communication terminal 20 an HTTP (Hyper Text Transfer Protocol) request including a URL, as a request for web content. The communicating unit 1 inputs the received request for web content to the obtaining unit 2.

The communicating unit 1 receives communication terminal information from the communication terminal 20. The communication terminal information is information indicating the performance of the communication terminal 20 such as communication speed, computing power, screen resolution, and screen size and the states of the communication terminal 20 such as packet loss rate and remaining battery level. The timing at which the communicating unit 1 receives communication terminal information may be any. For example, communication terminal information may be received at the same time as a request for web content. Alternatively, the content providing apparatus 10 may request the communication terminal 20 for communication terminal information as necessary, and obtain the communication termination information from the communication terminal 20. The communicating unit 1 inputs the communication terminal information to the determining unit 4.

The communicating unit 1 transmits to the communication terminal 20 web content that has been changed as necessary by the changing unit 5 (described later).

The obtaining unit 2 accepts the request for web content from the communicating unit 1. The obtaining unit 2 obtains the web content from a web server apparatus 30, according to the request for web content. The obtaining unit 2 obtains the web content by, for example, referring to a URL included in an HTTP request. The obtaining unit 2 inputs the obtained web content to the analyzing unit 3. The content providing apparatus 10 may be configured to also serve as the web server apparatus 30.

The analyzing unit 3 accepts the web content from the obtaining unit 2. The analyzing unit 3 analyzes the web content. Specifically, the analyzing unit 3 specifies whether the web content includes a description of a process using a scripting language (hereinafter, referred to as “script information”). In addition, the analyzing unit 3 estimates the processing load of the web content. The analyzing unit 3 estimates the processing load of the web content by, for example, the number of lines of the source code (HTML file, etc.) of the web content or the number of lines of description of processing using a scripting language included in the web content. Alternatively, for example, periods of time required to display pieces of web content may be measured in advance and the display periods of time for respective pieces of web content may be stored in the content providing apparatus 10, and the analyzing unit 3 may estimate the processing load of web content using the display periods of time.

The analyzing unit 3 further concretely specifies processing which uses a scripting language. The web content including the script information is a parallax website, for example. The parallax website is a website that represents a visual effect such as animation by changing an image in accordance with scrolling of a browser.

The method for concretely specifying processing which uses a scripting language may be any. For example, in the case of specifying that the processing using a scripting language is a parallax website, the analyzing unit 3 may hold in advance a list of plug-ins, libraries, etc., which are used to create parallax websites, and specify, as a parallax website, web content that uses a plug-in and a library included in the list. Alternatively, the analyzing unit 3 may specify whether the website is a parallax website by analyzing a description written using a scripting language, to specify whether animation where an image moves in accordance with scrolling is used.

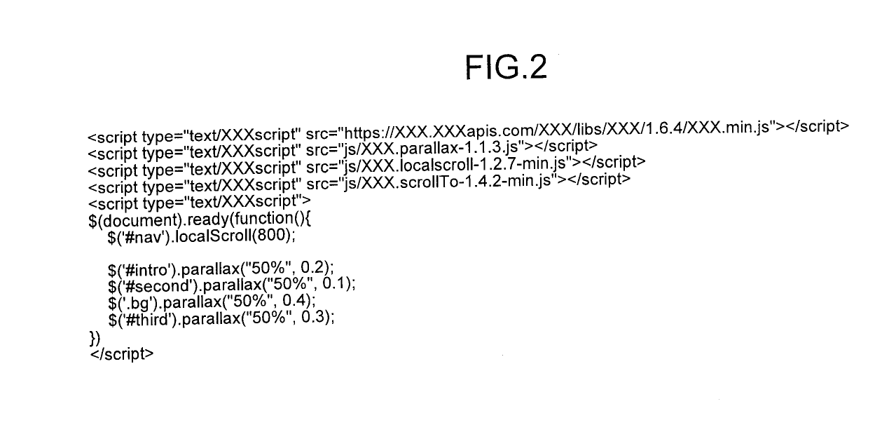

FIG. 2 is a diagram illustrating an example of script information included in web content. The analyzing unit 3 specifies whether the source code of web content includes a description indicating processing which uses a scripting language. In the example of FIG. 2, “XXXscript” is the description indicating processing which uses a scripting language. The analyzing unit 3 further concretely specifies processing which uses a scripting language. For example, when the source code of web content includes a description of a plug-in used to create a parallax website, the analyzing unit 3 specifies that the web content is a parallax website. In the example of FIG. 2, “XXX.parallax-1.1.3.js” is the description of a plug-in which is used to create a parallax website.

The analyzing unit 3 may not only specify whether the web content includes script information, but also analyze the web content to specify other information. The case in which the analyzing unit 3 analyzes layout information indicating layout used when the web content is displayed will be described later as a second embodiment. In addition, the case in which the analyzing unit 3 specifies whether web content includes animation will be described later as a third embodiment.

Referring back to FIG. 1, the analyzing unit 3 inputs the web content and the results of the analysis of the web content to the determining unit 4.

The determining unit 4 accepts the results of the analysis from the analyzing unit 3. The determining unit 4 also accepts the above-described communication terminal information from the communicating unit 1. When the web content includes script information, the determining unit 4 determines a method for changing the web content, according to the communication terminal information. The determining unit 4 also determines a concrete method for changing the script information. The determining unit 4 inputs the change methods to the changing unit 5.

An example of a method for determining, by the determining unit 4, a method for changing script information of web content will be first described.

For example, when the determining unit 4 obtains communication terminal information through the communicating unit 1 and the communication terminal information satisfies a predetermined condition (hereinafter, referred to as a “first condition”), the determining unit 4 may determine to change the web content to rich web content or not to change the web content. When the communication terminal information does not satisfy the first condition, the determining unit 4 may determine to change the web content in such a manner to reduce the processing load on the communication terminal 20 that displays the web content. The first condition is an arbitrary combination of conditions about the performance of the communication terminal 20 such as communication speed, computing power, screen resolution, and screen size and the states of the communication terminal 20 such as remaining battery level and packet loss rate. Changing the web content to rich web content refers to an improvement of the quality or amount of data of the web content. The web content is changed to rich web content by, for example, increasing the resolution or size of an image included in the web content.

In addition, for example, the determining unit 4 may transmit a probe packet to the communication terminal 20 through the communicating unit 1 to calculate, as communication terminal information, packet loss rate between the content providing apparatus 10 and the communication terminal 20. When the packet loss rate is smaller than a first threshold value, the determining unit 4 may determine to change the web content to rich web content or not to change the web content. When the packet loss rate is greater than or equal to the first threshold value, the determining unit 4 may determine to change the web content in such a manner to reduce the process of the communication terminal 20 that displays the web content.

Next, an example of a method for reducing the processing of the communication terminal 20 that displays web content or changing web content to rich web content, by changing script information of the web content will be described. First, the case of reducing the processing of the communication terminal 20 that displays web content will be described. The determining unit 4 determines a method for reducing the processing of the communication terminal 20 that displays web content, according to the processing load of the web content. The determining unit 4, for example, determines a method for reducing the processing by setting a plurality of threshold values.

As an example of the method for reducing the processing by setting a plurality of threshold values, the case in which web content is a parallax website will be specifically described. The determining unit 4, for example, sets two threshold values: a threshold value T1 and a threshold value T2 (T1>T2). When the number of lines of the source code (HTML file, etc.) of the web content is greater than T1, the determining unit 4 determines to convert script information so as to fix an image used for animation. When the number of lines of the source code (HTML file, etc.) of the web content is less than or equal to T1 but is greater than T2, the determining unit 4 determines to convert the script information so as to reduce the frequency of changing the position of the image.

When the web content is to be changed to rich web content in the case of the web content being a parallax website, the determining unit 4 determines to convert the script information such that the image moves more smoothly, for example.

The changing unit 5 accepts the change method from the determining unit 4. The changing unit 5 converts or deletes some or all of the script information of the web content, according to the change method determined by the determining unit 4.

A method for changing web content by the changing unit 5 will be described for the case in which the web content is a parallax website. When an image used for animation is to be fixed, the changing unit 5, for example, deletes all of the script information illustrated in FIG. 2. When the frequency of changing the position of the image used for animation is to be reduced, the changing unit 5, for example, converts a part of an image update processing where the position of the image is changed by scrolling of even a single pixel, such that the position of the image is changed when a certain number or more of pixels are scrolled. In addition, when the image used for animation is to be further smoothed, a part where the position of the image is changed by scrolling of a certain number or more of pixels is converted such that the position of the image is changed by scrolling of even a single pixel. Note that a part of the script information converted by the changing unit 5 when the frequency of updating the image is changed is, for example, an argument of the update function used in the processing of updating the image.

The changing unit 5 may not only change the frequency of updating the image, but also perform conversion for adjusting the size, position, etc., of the image. The changing unit 5 inputs to the communicating unit 1 the web content changed according to the change method determined by the determining unit 4. When the determining unit 4 determines not to change the web content, the changing unit 5 inputs the web content to the communicating unit 1 without changing the web content.

Although in the above description a parallax website is used as an example of web content including script information, the web content including script information is not limited to a parallax website. Namely, the content providing apparatus 10 may flexibly change web content other than a parallax website that includes script information and provide the web content to the communication terminal 20. Specifically, the content providing apparatus 10 holds in advance, for example, a list of plug-ins or libraries with a high processing load and records, for each plug-in or library, information required to determine a change method and a change method according to the information. With this, the content providing apparatus 10 can flexibly change web content other than a parallax website that includes script information and provide the web content to the communication terminal 20.

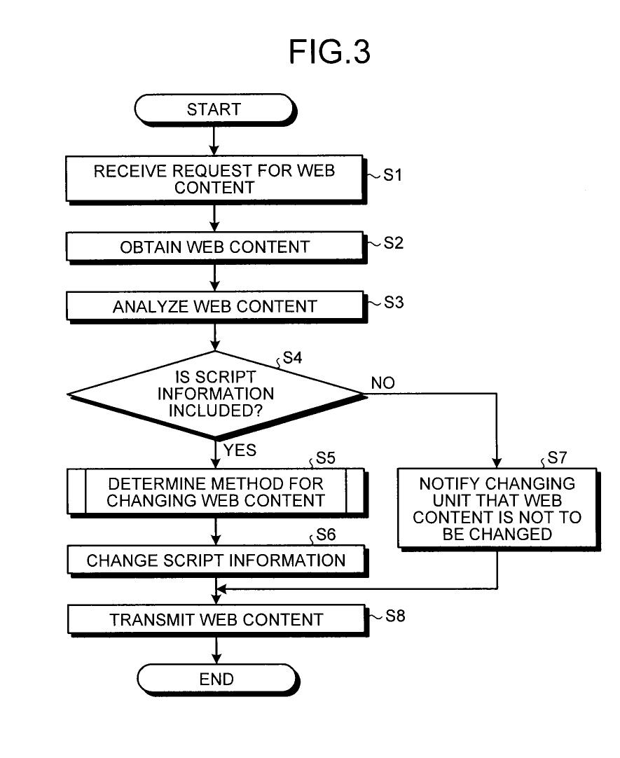

Next, a method for providing content of the first embodiment will be described. FIG. 3 is a flowchart illustrating an example of a method for providing content of the first embodiment. The communicating unit 1 receives a request for web content from the communication terminal 20 (step S1). Then, the obtaining unit 2 obtains the web content from the web server apparatus 30, according to the request for web content (step S2).

The analyzing unit 3 analyzes the web content (step S3). Specifically, the analyzing unit 3 specifies whether the web content includes the above-described script information. In addition, the analyzing unit 3 estimates the processing load of the web content. The analyzing unit 3 concretely specifies processing which uses a scripting language. The analyzing unit 3 inputs the web content and the results of the analysis of the web content to the determining unit 4.

The determining unit 4 determines whether the web content includes script information (step S4).

If script information is not included (No at step S4), the determining unit 4 notifies the changing unit 5 that the web content is not to be changed (step S7). The changing unit 5 transmits the web content to the communication terminal 20 through the communicating unit 1 without changing the web content (step S8).

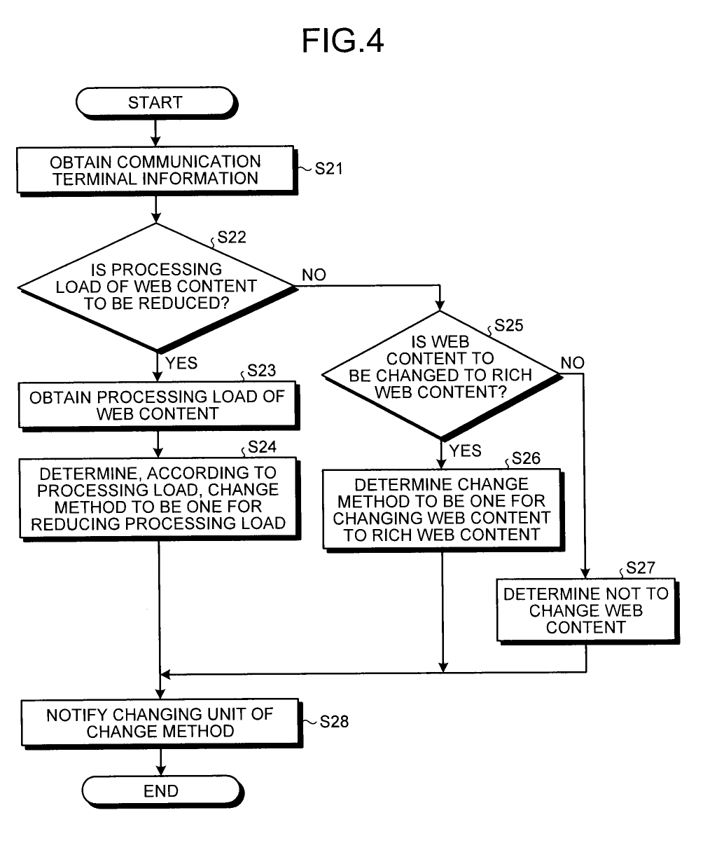

If script information is included (Yes at step S4), the determining unit 4 determines a method for changing the web content (step S5). Here, a method for determining, by the determining unit 4, a method for changing the web content will be described with reference to FIG. 4.

FIG. 4 is a flowchart illustrating a method for determining a method for changing web content of the first embodiment. The determining unit 4 obtains the above-described communication terminal information (step S21). Then, the determining unit 4 determines, according to the communication terminal information, whether to reduce the processing load of the web content (step S22).

If the processing load is to be reduced (Yes at step S22), the determining unit 4 obtains the processing load of the web content which is estimated by the analyzing unit 3 analyzing the web content (step S23). Then, the determining unit 4 determines, according to the processing load of the web content, a method for changing the web content for reducing the processing load (step S24). For example, when the web content is a parallax website, the determining unit 4 determines to convert the script information so as to fix an image used for animation.

If the processing load is not to be reduced (No at step S22), the determining unit 4 determines, according to the communication terminal information, whether to change the web content to rich web content (step S25). If the web content is to be changed to rich web content (Yes at step S25), the determining unit 4 determines a method for changing the web content to rich web content (step S26). For example, when the web content is a parallax website, the determining unit 4 determines to convert the script information such that the image moves more smoothly.

If the web content is not to be changed to rich web content (No at step S25), the determining unit 4 determines not to change the web content (step S27).

Then, the determining unit 4 notifies the changing unit 5 of the change method (step S28).

Referring back to FIG. 3, the changing unit 5 then changes the script information of the web content, according to the change method determined by the determining unit 4 (step S6). Then, the communicating unit 1 transmits the web content changed by the changing unit 5 to the communication terminal 20 (step S8).

As described above, according to the content providing apparatus 10 of the first embodiment, script information of web content can be flexibly changed based on communication terminal information and the web content, and then the web content can be provided to the communication terminal 20. With this, the usability of the communication terminal 20 can be improved.

### Second Embodiment

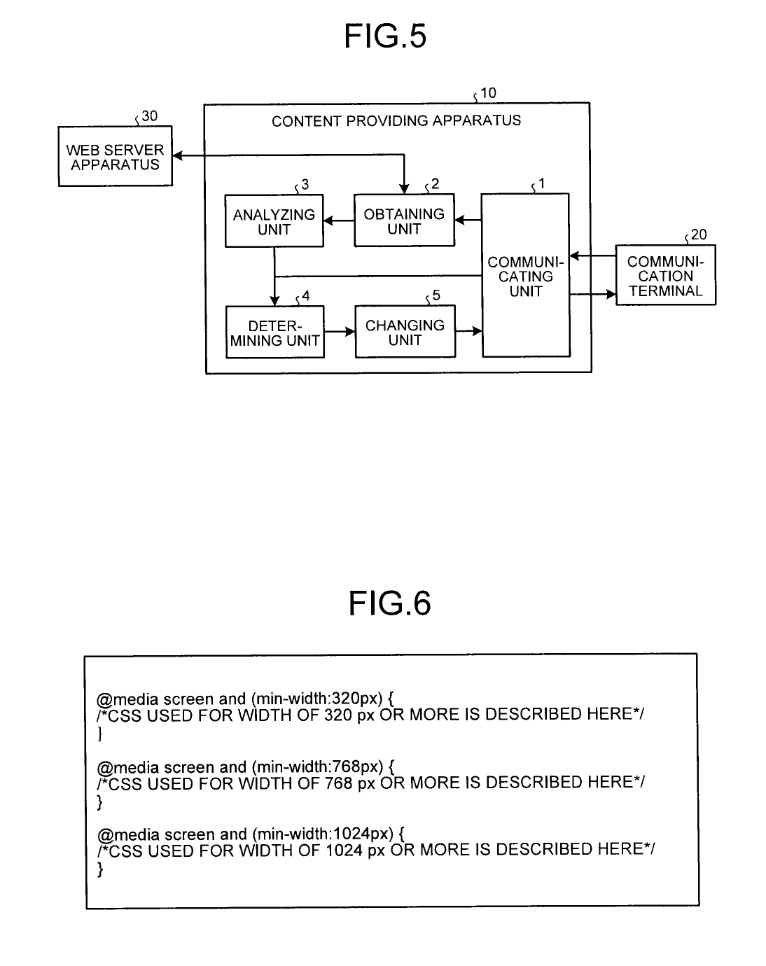

Next, a second embodiment will be described. The second embodiment describes the case in which an analyzing unit 3 analyzes layout information indicating layout used when web content is displayed. FIG. 5 is a diagram illustrating an example of a configuration of a content providing apparatus 10 of the second embodiment. The content providing apparatus 10 of the second embodiment includes a communicating unit 1, an obtaining unit 2, an analyzing unit 3, a determining unit 4, and a changing unit 5. The configuration of the content providing apparatus 10 of the second embodiment is the same as that of the first embodiment. In the description of the second embodiment, differences from the first embodiment will be described.

The analyzing unit 3 analyzes layout information indicating layout used when web content is displayed. The layout information is, for example, style sheets such as CSS (Cascading Style Sheets). The analyzing unit 3 analyzes the layout information to estimate the load of layout processing for web content which is performed when a communication terminal 20 displays the web content. An example of web content having layout information with a high load of layout processing on the communication terminal 20 includes a responsive website adopting responsive web design. The responsive website is a site whose design is dynamically changed to optimized layout, according to the window size of the communication terminal 20.

FIG. 6 is a diagram illustrating an example of layout information of a responsive website. In the example of FIG. 6, different style sheets are defined for different window sizes, using Media Queries. Since style sheets of three patterns for a width of 320 pixels or more, a width of 768 pixels or more, and a width of 1024 pixels or more are defined, the analyzing unit 3 specifies that the web content is a responsive website.

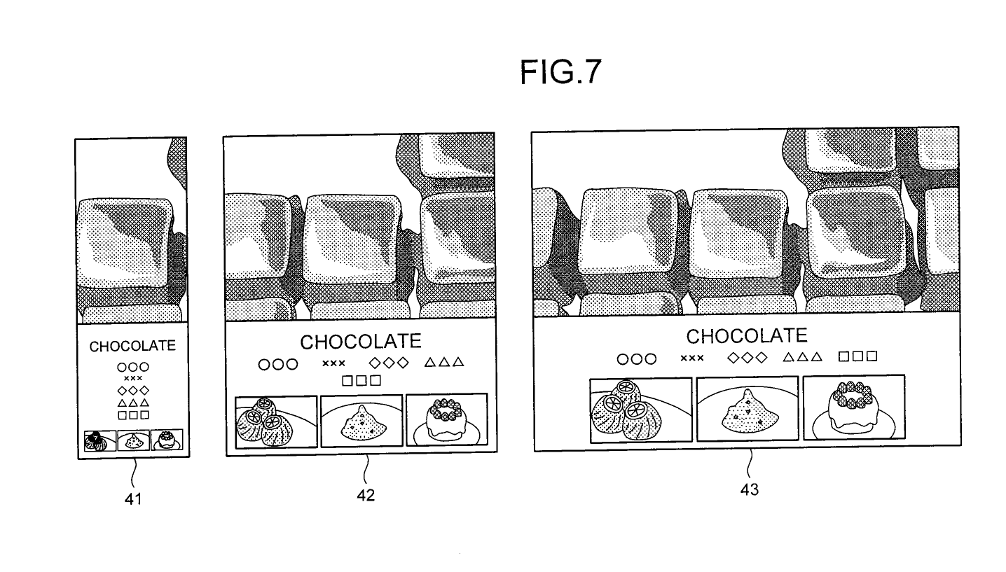

FIG. 7 is a diagram illustrating an example of a responsive website. FIG. 7 illustrates an example of the case in which web content having the layout information illustrated in FIG. 6 is displayed by a plurality of communication terminals 20 with different screen sizes. Layout 41 illustrates an example of the case in which the web content is displayed on a communication terminal 20 (e.g., a smartphone) with a width of 320 pixels or more. Layout 42 illustrates an example of the case in which the web content is displayed on a communication terminal 20 (e.g., a tablet terminal) with a width of 768 pixels or more. Layout 43 illustrates an example of the case in which the web content is displayed on a communication terminal 20 (e.g., a personal computer) with a width of 1024 pixels or more.

The method for analyzing, by the analyzing unit 3, web content to specify whether the load of layout processing for the web content is high may be any. The analyzing unit 3 may specify whether the load of layout processing for web content is high by, for example, the number of lines of the source code (HTML file, etc.) of the web content.

Referring back to FIG. 5, the analyzing unit 3 inputs web content and the result of the analysis of the web content to the determining unit 4.

The determining unit 4 accepts the result of the analysis from the analyzing unit 3. The determining unit 4 also accepts the above-described communication terminal information from the communicating unit 1. The determining unit 4 determines a method for changing the web content, according to the layout information of the web content and the communication terminal information. The determining unit 4 inputs the change method to the changing unit 5.

Here, an example of a method for changing web content which is determined by the determining unit 4 according to the layout information of the web content and communication terminal information will be described.

The determining unit 4, for example, refers to the screen size of the communication terminal 20, as communication terminal information. The determining unit 4 obtains the screen size from, for example, terminal information included in UA (User Agent) information in an HTTP request received from the communication terminal 20. The determining unit 4 may hold in advance pairs of UA information and screen size so that the determining unit 4 can search for the screen size of the communication terminal 20 from UA information.

When, for example, the web content is a responsive website, the determining unit 4 may determine to change the layout information of the web content, according to the screen size of the communication terminal 20. Specifically, when the screen size of the communication terminal 20 is smaller than a second threshold value, the determining unit 4 may determine to make a change to perform trimming or size reduction of the web content. In addition, when the screen size of the communication terminal 20 is greater than or equal to the second threshold value, the determining unit 4 may determine to change the web content to rich web content by adding a new style sheet where the web content is made compatible with the screen size, to the web content. The case in which the screen size of the communication terminal 20 is greater than or equal to the second threshold value is, for example, a case in which the communication terminal 20 has a multi-monitor configuration.

In the case of the web content being other than a responsive website, when the number of lines of the source code (HTML file, etc.) of the web content is greater than a third threshold value and the communication terminal information does not satisfy a predetermined condition (hereinafter, referred to as a “second condition”), the determining unit 4 may determine to change the layout information in such a manner to reduce the processing of the communication terminal 20 that displays the web content. A plurality of third threshold values and a plurality of second conditions may be defined. For example, a smaller third threshold value may be defined for such a second condition that indicates a communication terminal 20 with lower processing performance.

The changing unit 5 accepts the change method from the determining unit 4. The changing unit 5 changes the layout information of the web content, according to the change method determined by the determining unit 4.

When the web content is to be changed to rich web content, the changing unit 5, for example, converts a description of a style sheet of the web content such that an image included in the web content is displayed in a larger size.

When the processing load on the communication terminal 20 that displays the web content of a responsive website is to be reduced, the changing unit 5, for example, performs trimming or size reduction of the web content, according to the screen size included in the communication terminal information. Specifically, in the case in which the width of the screen size of the communication terminal 20 is 320 pixels, when layout information (style sheet) describes that the size of an image included in web content is reduced to 30% of its original size, the changing unit 5 makes a change to reduce the size of the image to 30%. With this, the amount of data of the web content can be reduced. In addition, by the changing unit 5 performing screen processing (trimming or size reduction) to be performed by the communication terminal 20, the processing of the communication terminal 20 that displays the web content is reduced.

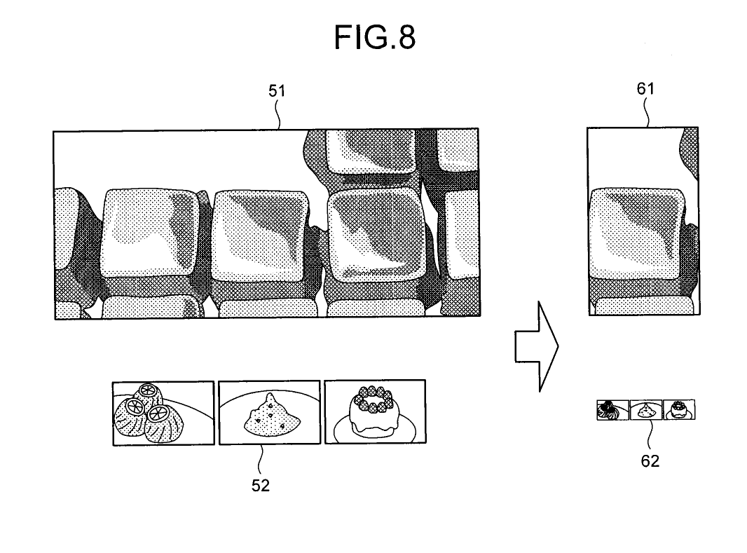

FIG. 8 is a diagram illustrating an example of changes made by the trimming and size reduction of images. The changing unit 5 performs trimming and size reduction of an image 51 included in web content, and thereby changes the image 51 to an image 61. In addition, the changing unit 5 performs trimming and size reduction of an image 52 included in the web content, and thereby changes the image 52 to an image 62.

When the layout information is to be changed to reduce the process of the communication terminal 20 that displays the web content, the changing unit 5 may make a change to designate the position of an image included in the web content.

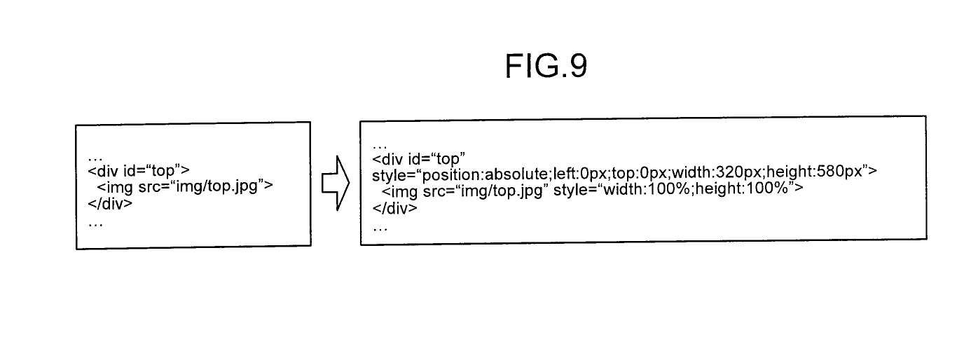

FIG. 9 is a diagram illustrating an example of a change made to designate the position of an image. The example of FIG. 9 is an example of the case in which the changing unit 5 changes web content such that the position of “top.jpg” is designated using a “position” style attribute. This can eliminate the need for the communication terminal 20 to perform layout computation for “top.jpg”, enabling to reduce the processing load on the communication terminal 20 that displays “top.jpg” contained in the web content. The position information of an HTML element such as “top.jpg” can be obtained from the web content using getBoundingRect API, for example.

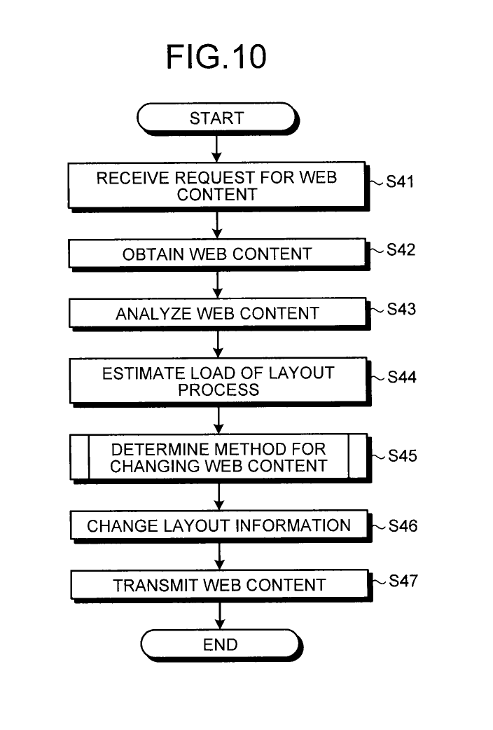

Next, a method for providing content of the second embodiment will be described. FIG. 10 is a flowchart illustrating an example of a method for providing content of the second embodiment. The communicating unit 1 receives a request for web content from the communication terminal 20 (step S41). Then, the obtaining unit 2 obtains the web content from a web server apparatus 30, according to the request for web content (step S42).

The analyzing unit 3 analyzes the web content (step S43). Specifically, the analyzing unit 3 analyzes the web content and thereby analyzes layout information indicating layout used when the web content is displayed. Then, the analyzing unit 3 analyzes the layout information to estimate the load of layout processing for the web content which is performed when the communication terminal 20 displays the web content (step S44). The analyzing unit 3 inputs the web content and the result of the analysis of the web content to the determining unit 4.

Then, the determining unit 4 determines a method for changing the web content (step S45). Now, a method for determining, by the determining unit 4, a method for changing the web content will be described. A flowchart illustrating a method for determining, by the determining unit 4, a method for changing the web content of the second embodiment is the same as that in FIG. 4 of the first embodiment, and thus, a description will be made with reference to FIG. 4.

The determining unit 4 obtains the above-described communication terminal information (step S21). Then, the determining unit 4 determines, according to the communication terminal information, whether to reduce the processing load of the web content (step S22).

If the processing load is to be reduced (Yes at step S22), the determining unit 4 obtains the processing load of the web content which is estimated by the analyzing unit 3 analyzing the web content (step S23). Then, the determining unit 4 determines, according to the processing load of the web content, a method for changing the web content for reducing the processing load (step S24). For example, when the screen size of the communication terminal 20 is smaller than the second threshold value, the determining unit 4 may determine to make a change to perform trimming or size reduction of the web content.

If the processing load is not to be reduced (No at step S22), the determining unit 4 determines, according to the communication terminal information, whether to change the web content to rich web content (step S25). If the web content is to be changed to rich web content (Yes at step S25), the determining unit 4 determines a method for changing the web content to rich web content (step S26). For example, when the screen size of the communication terminal 20 is greater than or equal to the second threshold value, the determining unit 4 may determine to change the web content to rich web content by adding a new style sheet where the web content is made compatible with the screen size, to the web content.

If the web content is not to be changed to rich web content (No at step S25), the determining unit 4 determines not to change the web content (step S27).

Then, the determining unit 4 notifies the changing unit 5 of the change method (step S28).

Referring back to FIG. 10, the changing unit 5 then changes the layout information of the web content, according to the change method determined by the determining unit 4 (step S46). Then, the communicating unit 1 transmits the web content changed by the changing unit 5 to the communication terminal 20 (step S47).

As described above, according to the content providing apparatus 10 of the second embodiment, layout information of web content can be flexibly changed based on communication terminal information and the web content, and then the web content can be provided to the communication terminal 20. With this, the usability of the communication terminal 20 can be improved.

### Third Embodiment

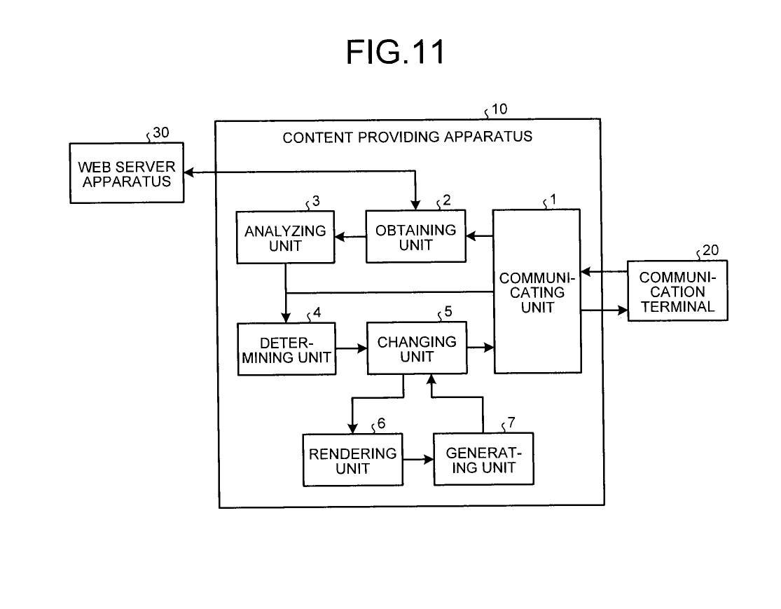

Next, a third embodiment will be described. The third embodiment describes the case in which an analyzing unit 3 analyzes whether web content includes animation. FIG. 11 is a diagram illustrating an example of a configuration of a content providing apparatus 10 of the third embodiment. The content providing apparatus 10 of the third embodiment includes a communicating unit 1, an obtaining unit 2, an analyzing unit 3, a determining unit 4, a changing unit 5, a rendering unit 6, and a generating unit 7. In the configuration of the content providing apparatus 10 of the third embodiment, the rendering unit 6 and the generating unit 7 are added to the configuration of the first embodiment. In the description of the third embodiment, differences from the first embodiment will be described.

The analyzing unit 3 analyzes whether web content includes animation. The format of the animation included in the web content may be any. The animation is, for example, animation using a scripting language, CSS (Cascading Style Sheets) animation, SVG (Scalable Vector Graphics) animation, and GIF (Graphics Interchange Format) animation.

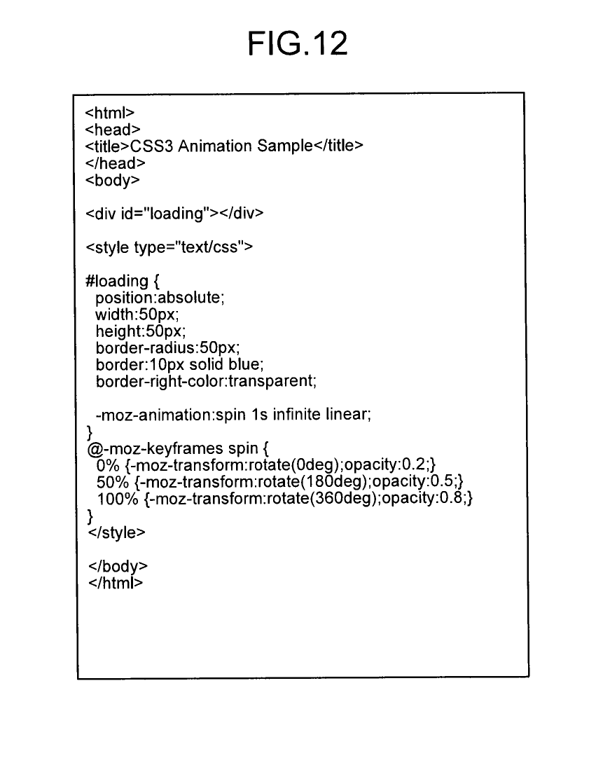

FIG. 12 is a diagram illustrating an example of web content using CSS3 animation. The example of FIG. 12 is an example in which animation is implemented by using animation properties in a style sheet. For example, when analysis of a style sheet by the analyzing unit 3 shows that animation properties are set, the analyzing unit 3 specifies that the web content includes CSS3 animation.

Referring back to FIG. 11, the analyzing unit 3 inputs the web content and the result of the analysis of the web content to the determining unit 4.

The determining unit 4 accepts the result of the analysis from the analyzing unit 3. The determining unit 4 also accepts the above-described communication terminal information from the communicating unit 1. The determining unit 4 determines, according to the communication terminal information, a method for changing the web content. The determining unit 4 inputs the change method to the changing unit 5.

Here, an example of a method for changing web content which is determined by the determining unit 4 according to communication terminal information will be described.

The determining unit 4 obtains, for example, as communication terminal information, information indicating whether a communication terminal 20 has a hardware decoder. Then, when the communication terminal 20 has a hardware decoder, the determining unit 4 determines to convert animation included in web content into a moving image in a hardware decodable format. An example of the moving image in a hardware decodable format includes MPEG-4.

In addition, for example, the determining unit 4 may transmit a probe packet to the communication terminal 20 through the communicating unit 1 to calculate, as communication terminal information, packet loss rate between the content providing apparatus 10 and the communication terminal 20. When the packet loss rate is greater than or equal to a fourth threshold value, the determining unit 4 may determine to change the web content in such a manner to reduce the process of the communication terminal 20 that displays the web content. Namely, the determining unit 4 may determine, according to the quality of a network, to change animation included in the web content to a moving image file in a hardware decodable format. In this case, when the amount of data in the moving image file is larger than the animation included in the web content, the determining unit 4 does not determine to change the animation to a moving image file.

The determining unit 4 may determine the amount of data in the moving image file by the actually created moving image file. In this case, creation of the moving image file is performed by the rendering unit 6 and the generating unit 7 which will be described later. The determining unit 4 may estimate the amount of data in the moving image file, using history information. For example, the amount of data in the moving image file may be estimated according to a URL of the web content, from history information indicating a URL of web content and the amount of data in a moving image file into which animation included in the URL is converted. Alternatively, the determining unit 4 may estimate the amount of data in the moving image file, according to the format of the animation included in the web content. For example, in the case of GIF animation, the amount of data in the moving image file is larger. Alternatively, the determining unit 4 may estimate the amount of data in the moving image file, according to the description of the animation included in the web content. For example, the amount of data in the moving image file may be estimated, according to the number of SVG elements in SVG animation.

The method for evaluating, by the determining unit 4, the quality of a network is not limited to the one by calculating packet loss rate using a probe packet, and may be any.

The changing unit 5 accepts the change method from the determining unit 4. The change method of the third embodiment includes a moving image format into which the animation included in the web content is converted, and designation of the animation to be converted which is included in the web content. The changing unit 5 converts the animation in the web content into a moving image file in a hardware decodable format, according to the change method determined by the determining unit 4, and changes the web content such that the moving image file is referred to from the web content. When the determining unit 4 determines not to convert the format of the animation included in the web content, the changing unit 5 does not change the web content.

When the changing unit 5 changes the format of the animation included in the web content, the changing unit 5 transmits to the rendering unit 6 a rendering instruction to start rendering of the web content.

When the rendering unit 6 receives the rendering instruction from the changing unit 5, the rendering unit 6 renders the web content. The rendering unit 6, for example, has a buffer for storing rendering information in a size according to the screen size of the communication terminal 20, and renders the web content in the buffer. The buffer is a RAM (Random Access Memory), an HDD (Hard Disk Drive), an optical disk, a memory card, or the like. The rendering unit 6 may be implemented by, for example, a browser or a UI (User Interface) testing tool.

The generating unit 7 periodically obtains rendering information from the buffer of the rendering unit 6, and encodes the rendering information and thereby generates moving image information (moving image file). When the generating unit 7 obtains rendering information from the buffer every 33 milliseconds, for example, a 30 fps moving image file is created. When the rendering unit 6 is a browser, rendering information may be periodically obtained using an API which is prepared as a browser development environment. The generating unit 7 may encode rendering information which is periodically obtained using a video converter program such as the avconv program, into moving image information.

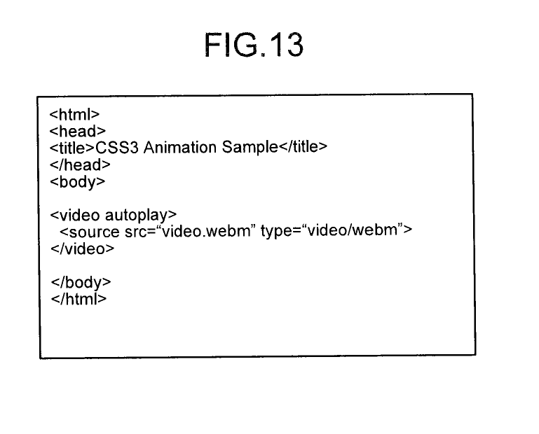

FIG. 13 is a diagram illustrating an example in which CSS3 animation is changed to a scheme to refer to a moving image file. FIG. 13 illustrates an example in which the CSS animation in the web content illustrated in FIG. 12 is changed to a scheme to refer to the moving image file “video.webm”, using the “video” tag which is an HTML element.

Referring back to FIG. 11, when the format of the animation included in the web content is to be changed, the changing unit 5 changes the web content to a scheme to refer to the moving image file created by the generating unit 7. The changing unit 5 inputs the web content changed according to the change method which is determined by the determining unit 4, to the communicating unit 1.

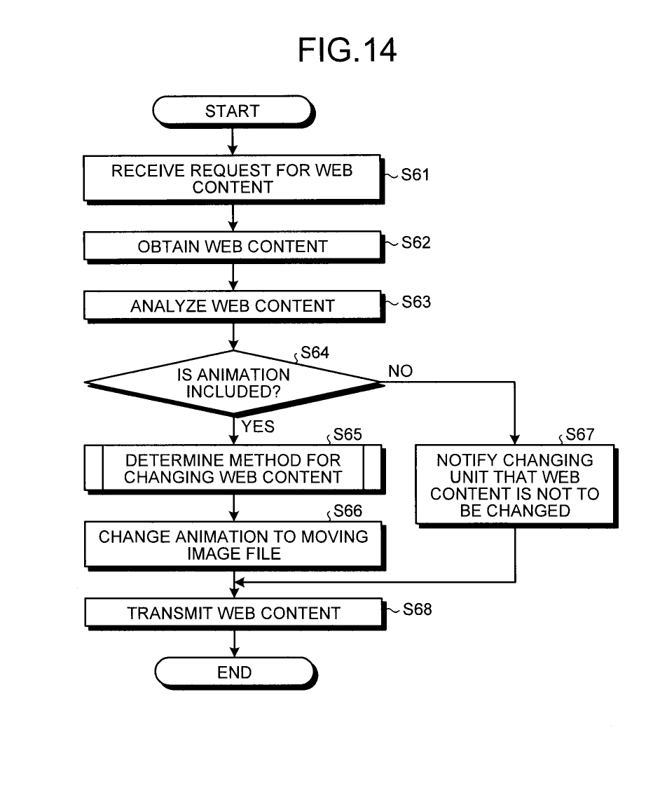

Next, a method for providing content of the third embodiment will be described. FIG. 14 is a flowchart illustrating an example of a method for providing content of the third embodiment. The communicating unit 1 receives a request for web content from the communication terminal 20 (step S61). Then, the obtaining unit 2 obtains the web content from a web server apparatus 30, according to the request for web content (step S62).

The analyzing unit 3 analyzes the web content (step S63). Specifically, the analyzing unit 3 analyzes whether the web content includes animation.

The determining unit 4 determines whether the web content includes animation (step S64).

If animation is not included (No at step S64), the determining unit 4 notifies the changing unit 5 that the web content is not to be changed (step S67). The changing unit 5 transmits the web content to the communication terminal 20 through the communicating unit 1 without changing the web content (step S68).

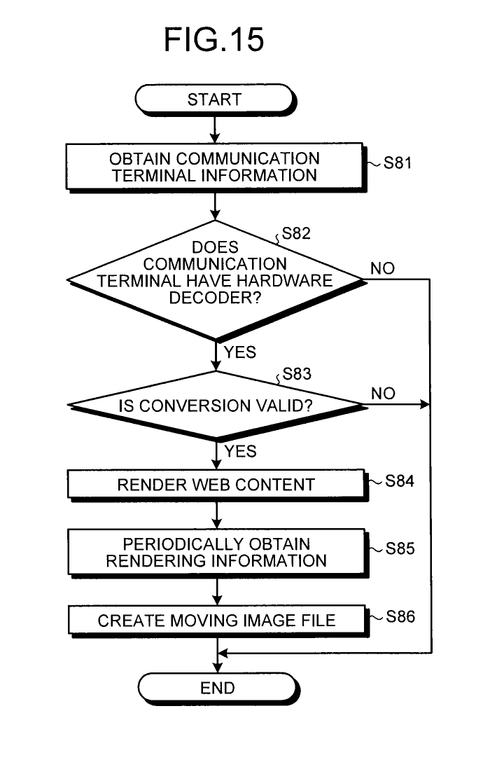

If animation is included (Yes at step S64), the determining unit 4 determines a method for changing the web content (step S65). Here, a method for determining, by the determining unit 4, a method for changing the web content will be described with reference to FIG. 15.

FIG. 15 is a flowchart illustrating a method for determining a method for changing web content of the third embodiment. The determining unit 4 obtains the above-described communication terminal information (step S81). Specifically, the determining unit 4 obtains information indicating whether the communication terminal 20 has a hardware decoder, from the communication terminal information. Then, the determining unit 4 determines whether the communication terminal 20 has a hardware decoder (step S82).

If the communication terminal 20 does not have a hardware decoder (No at step S82), the process ends without changing the web content. If the communication terminal 20 has a hardware decoder (Yes at step S82), processing proceeds to step S83.

The determining unit 4 determines whether conversion of the animation included in the web content into a moving image in a hardware decodable format is valid (step S83).

If the conversion is not valid (No at step S83), processing ends without changing the web content. The case in which the conversion is not valid is, for example, a case in which the amount of data in the moving image file is larger than the animation included in the web content.

If the conversion is valid (Yes at step S83), processing proceeds to step S84. The case in which the conversion is valid is, for example, a case in which the amount of data in the moving image file is smaller than the animation included in the web content.

The rendering unit 6 renders the web content (step S84). Then, the generating unit 7 periodically obtains rendering information from the buffer of the rendering unit 6 (step S85), and encodes the rendering information and thereby generates moving image information (moving image file) (step S86).

Referring back to FIG. 14, the changing unit 5 then changes the animation in the web content to a scheme to refer to a moving image file, according to the change method determined by the determining unit 4 (step S66). Then, the communicating unit 1 transmits the web content changed by the changing unit 5 to the communication terminal 20 (step S68).

As described above, according to the content providing apparatus 10 of the third embodiment, animation in web content can be changed to a moving image file, based on communication terminal information and the format of the animation in the web content, and then the web content can be provided to the communication terminal 20. With this, the processing load for when the communication terminal 20 displays the web content can be reduced, enabling to improve usability.

In the above description, the case of converting animation into a moving image file is described. However, web content with a high rendering load other than animation may be converted into a file format other than a moving image file. The file is, for example, a PNG image file.

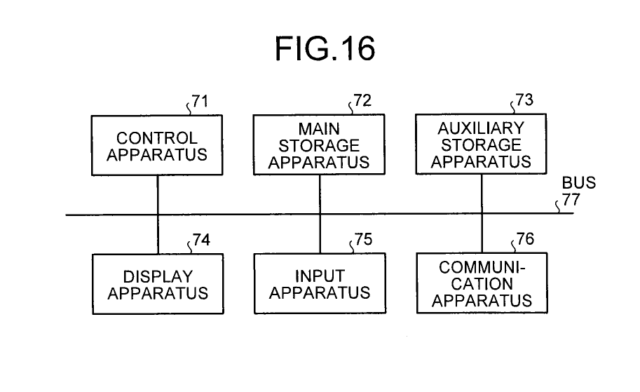

Finally, an example of a hardware configuration of the content providing apparatuses 10 of the first to third embodiments will be described. FIG. 16 is a diagram illustrating an example of a hardware configuration of the content providing apparatuses 10 of the first to third embodiments. The content providing apparatuses 10 of the first to third embodiments include a control apparatus 71, a main storage apparatus 72, an auxiliary storage apparatus 73, a display apparatus 74, an input apparatus 75, and a communication apparatus 76. The control apparatus 71, the main storage apparatus 72, the auxiliary storage apparatus 73, the display apparatus 74, the input apparatus 75, and the communication apparatus 76 are connected to each other through a bus 77. The content providing apparatuses 10 may be any apparatus having the above-described hardware configuration. For example, the content providing apparatuses 10 are server apparatuses.

The control apparatus 71 executes a program read from the auxiliary storage apparatus 73 to the main storage apparatus 72. The main storage apparatus 72 is a memory such as a ROM or a RAM. The auxiliary storage apparatus 73 is an HDD or the like. The display apparatus 74 displays, for example, the state of the content providing apparatus 10. The input apparatus 75 accepts an operation input from a user. The communication apparatus 76 is an interface used by the content providing apparatus 10 to communicate with the communication terminal 20.

A program executed by the content providing apparatuses 10 of the first to third embodiments is provided as a computer program product, stored in a computer-readable storage medium, such as a CD-ROM, a memory card, a CD-R, or a DVD (Digital Versatile Disk), as an installable or executable format file.

Alternatively, a program executed by the content providing apparatuses 10 of the first to third embodiments may be provided such that the program is stored on a computer connected to a network such as the Internet, and downloaded via the network. Alternatively, a program executed by the content providing apparatuses 10 of the first to third embodiments may be provided via a network such as the Internet without downloading the program.

Alternatively, a program of the content providing apparatuses 10 of the first to third embodiments may be provided such that the program is pre-installed in a ROM or the like.

A program executed by the content providing apparatuses 10 of the first and second embodiments has a module configuration including the above-described functional blocks (the communicating unit 1, the obtaining unit 2, the analyzing unit 3, the determining unit 4, and the changing unit 5). A program executed by the content providing apparatus 10 of the third embodiment has a module configuration including the above-described functional blocks (the communicating unit 1, the obtaining unit 2, the analyzing unit 3, the determining unit 4, the changing unit 5, the rendering unit 6, and the generating unit 7). For the actual hardware of the functional blocks, by the control apparatus 71 reading a program from a storage medium and executing the program, the functional blocks are loaded onto the main storage apparatus 72. Namely, the functional blocks are generated on the main storage apparatus 72.

Note that some or all of the above-described units (the communicating unit 1, the obtaining unit 2, the analyzing unit 3, the determining unit 4, the changing unit 5, the rendering unit 6, and the generating unit 7) may be implemented by hardware such as an IC (Integrated Circuit), instead of being implemented by software.

As described above, according to the content providing apparatuses 10 of the first to third embodiments, by providing the above-described determining unit 4 that determines a method for changing web content, web content can be flexibly changed based on communication terminal information and the web content, and then the web content can be provided to the communication terminal 20.

By combining the first to third embodiments, the analyzing unit 3 may analyze all of script information, layout information, and animation included in web content, and the determining unit 4 may determine a change method based on communication terminal information and the results of the analysis of the web content. In this case, the changing unit 5 may change all of the script information, the layout information, and the animation. In addition, for the changes to the script information, layout information, and animation of the web content, the changing unit 5 may make the highest-priority change. Note that priorities may be arbitrarily defined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content providing apparatus comprising:
a receiving unit that receives a request for content from a communication terminal;
an analyzing unit that analyzes the content requested by the communication terminal;
a determining unit that determines a method for changing the content, based on a result of the analysis by the analyzing unit and communication terminal information indicating performance or state of the communication terminal;
a changing unit that changes the content by the change method determined by the determining unit; and
a transmitting unit that transmits the content changed by the changing unit to the communication terminal.

2. The apparatus according to claim 1, wherein
the determining unit obtains the communication terminal information from the communication terminal, and
when the communication terminal information satisfies a first condition, the determining unit determines to change the content to rich content or not to change the content, and when the communication terminal information does not satisfy the first condition, the determining unit determines to change the content in such a manner to reduce processing load on the communication terminal that displays the content.

3. The apparatus according to claim 2, wherein
the communication terminal information includes information indicative of remaining battery level, and
the first condition is that the remaining battery level is greater than a threshold value.

4. The apparatus according to claim 2, wherein
the communication terminal information includes information indicative of packet loss rate, and
the first condition is that the packet loss rate is smaller than a threshold value.

5. The apparatus according to claim 2, wherein
the communication terminal information includes information indicative of screen size, and
the first condition is that the screen size is greater than a threshold value.

6. The apparatus according to claim 1, wherein
the analyzing unit analyzes the content to specify whether the content includes script information indicating processing which uses a scripting language,
when the content includes the script information, the determining unit determines to convert or delete some or all of the script information, and
the changing unit converts or deletes some or all of the script information included in the content.

7. The apparatus according to claim 1, wherein
the analyzing unit analyzes the content to specify layout information indicating layout used when the content is displayed,
the determining unit determines to change the layout information in such a manner to reduce processing load on the communication terminal that displays the content, and
the changing unit changes the layout information.

8. The apparatus according to claim 1, further comprising:
a rendering unit that renders the content and outputs rendering information; and
a generating unit that generates moving image information by encoding the rendering information, wherein
the analyzing unit analyzes the content to specify whether the content includes animation,
when the content includes animation, the determining unit determines to change the animation to the moving image information, and
the changing unit deletes the animation included in the content and changes the content such that the moving image information is referred to from the content.

9. A content providing method comprising:
receiving, by a receiving unit, a request for content from a communication terminal;
analyzing, by an analyzing unit, the content requested by the communication terminal;
determining, by a determining unit, a method for changing the content, based on a result of the analysis by the analyzing unit and communication terminal information indicating performance or state of the communication terminal;
changing, by a changing unit, the content by the change method determined by the determining unit; and
transmitting, by a transmitting unit, the content changed by the changing unit to the communication terminal.

10. A computer program product comprising a computer-readable medium containing a computer program that causes a computer to function as:
a receiving unit that receives a request for content from a communication terminal;
an analyzing unit that analyzes the content requested by the communication terminal;
a determining unit that determines a method for changing the content, based on a result of the analysis by the analyzing unit and communication terminal information indicating performance or state of the communication terminal;
a changing unit that changes the content by the change method determined by the determining unit; and
a transmitting unit that transmits the content changed by the changing unit to the communication terminal.
